(19) United States
(12) Patent Application Publication
(10) Pub. No.: US 2026/0126148 A1
(43) Pub. Date: May 7, 2026

(54) DISPLAY ANGLE ADJUSTMENT DEVICE

(71) Applicant: Samsung Electronics Co., Ltd., Suwon-si (KR)

(72) Inventors: Heeseung CHOI, Suwon-si (KR); Daesoo Kim, Suwon-si (KR); Jinho Kim, Suwon-si (KR); Cheoggyu Hwang, Suwon-si (KR)

(73) Assignee: Samsung Electronics Co., Ltd., Suwon-si (KR)

(21) Appl. No.: 19/398,837

(22) Filed: Nov. 24, 2025

Related U.S. Application Data
(63) Continuation of application No. PCT/KR2024/006606, filed on May 14, 2024.

(30) Foreign Application Priority Data
Jul. 13, 2023 (KR) 10-2023-0091312

(51) Int. Cl. F16M 11/12; F16M 11/08; F16M 11/10; F16M 11/18

(52) U.S. Cl. CPC F16M 11/126; F16M 11/08; F16M 11/10; F16M 11/125; F16M 11/128; F16M 11/18

(57) ABSTRACT

A display angle adjustment device includes a base, a fixed shaft fixed to the base along an X-axis direction, a first driver provided on a first side of the base and including a first movable rod parallel with the fixed shaft, a second driver provided on a second side of the base such that the second driver is symmetrical to the first driver. The second driver includes a second movable rod parallel with the fixed shaft. A connection block to which a front end of the fixed shaft, a front end of the first movable rod, and a front end of the second movable rod are pivot-connected respectively. The device includes a holder connecting the connection block and a display, wherein the first movable rod and the second movable rod are configured to move along an X-axis direction to adjust an angle of the display.

### CROSS-REFERENCE TO RELATED APPLICATIONS

This application is a continuation of International Application No. PCT/KR2024/006606, filed on May 14, 2024, and claiming priority to Korean Patent Application No. 10-2023-0091312, filed on Jul. 17, 2023, in the Korean Intellectual Property Office, the disclosures of each of which are incorporated by reference herein in their entireties.

### BACKGROUND

### 1. Field

This disclosure relates to a display angle adjustment device adjusting a display at various angles.

### 2. Description of Related Art

A display device, as a device displaying a screen, includes a monitor or a television. For the display device, a self-light emitting display panel such as an organic light emitting diode or a micro light emitting diode, and a light receiving and emitting display panel such as a liquid crystal display panel are used. The display device is configured to include a display assembly displaying an image, and a stand supporting the display assembly approximately shaped into a plate, and the like.

### SUMMARY

According to an aspect of the disclosure, there is provided a display angle adjustment device including: a base; a fixed shaft fixed to the base along an X-axis direction; a first driver provided on a first side of the base and including a first movable rod parallel with the fixed shaft; a second driver provided on a second side of the base such that the second driver is symmetrical to the first driver, the second driver including a second movable rod parallel with the fixed shaft; a connection block to which a front end of the fixed shaft, a front end of the first movable rod, and a front end of the second movable rod are pivot-connected respectively; and a holder connecting the connection block and a display, wherein the first movable rod and the second movable rod are configured to move along an X-axis direction to adjust an angle of the display.

The first movable rod and the second movable rod are configured to move by an identical distance in an identical direction along an X-axis direction to rotate the display around a Y axis.

The first movable rod and the second movable rod are configured to move in a different direction along an X-axis direction to rotate the display around a Z axis.

The first movable rod and the second movable rod are configured to move in an identical direction along an X-axis direction by a different distance to rotate the display around a Y axis and a Z axis.

The display angle adjustment device further may include a third driver provided at the connection block to rotate the holder around a Y axis.

The display angle adjustment device further may include a gravity compensation interface supporting the first movable rod and the second movable rod elastically in a direction where the first movable rod and the second movable rod are configured to move toward the holder along an X-axis direction.

The first driver may include a first swiveling member hinge-connected to the first movable rod, wherein the second driver may include a second swiveling member hinge-connected to the second movable rod, and wherein the display angle adjustment device further may include: a central shaft penetrating the base in the X-axis direction, and connected to rotation centers of the first swiveling member and the second swiveling member; and a vibration absorbing structure elastically pressing the first swiveling member and the second swiveling member respectively against the base.

The vibration absorbing structure may include: a first elastic member and a second elastic member coupled to both ends of the central shaft respectively; a first frictional member provided between the first swiveling member and the base; a second frictional member provided between the second swiveling member and the base; a first bearing provided between the first swiveling member and the central shaft and adjacent to the first elastic member, and a second bearing adjacent to the first frictional member; and a third bearing provided between the second swiveling member and the central shaft and adjacent to the second elastic member, and a fourth bearing adjacent to the second frictional member.

The first bearing and the third bearing are angular contact ball bearings. 10.

The display angle adjustment device as claimed in claim 8, wherein materials of the first frictional member and the second frictional member are brass.

The first elastic member and the second elastic member are spring washers.

The holder has a rhombus shape of which a lower edge corresponding to a lower side of the display has a length greater than a length of an upper edge corresponding to an upper side of the display, and wherein both end portions of the lower side of the holder are fixed to a lower end portion of a left side of the display and a lower end portion of a right side of the display respectively.

A front end of the fixed shaft, a front end of the first movable rod, and a front end of the second movable rod are connected respectively by first, second and third universal joints.

According to an aspect of the disclosure, there is provided a display angle adjustment device including: a base; a first driver provided on a first side of the base; a second driver provided on a second side of the base such that the second driver is symmetrical to the first driver; a third driver provided at a front of the base; and a holder connecting the third driver and a display, wherein the first driver and the second driver rotate the display around an X axis and a Z axis, and wherein the third driver rotates the display around an Y axis.

The first driver may include a first movable rod connected to the holder, wherein the second driver may include a second movable rod parallel with the first movable rod and connected to the holder, and wherein the display angle adjustment device further may include a gravity compensation interface elastically supporting the first movable rod and the second movable rod in a direction where the first movable rod and the second movable rod are configured to move along an X-axis direction.

### BRIEF DESCRIPTION OF THE DRAWINGS

The above and other aspects and/or features of embodiments of the disclosure will become more apparent from the following detailed description taken in conjunction with the accompanying drawings, in which:

FIG. 1 is a view illustrating an example of a display angle adjustment device installed in a mobile robot according to one or more embodiments;

FIG. 2 is an exploded view illustrating an example of a display angle adjustment device connected to a display through a holder according to one or more embodiments;

FIG. 3 is an assembly view illustrating an example of a display angle adjustment device connected to a display through a holder according to one or more embodiments;

FIG. 4 is a view illustrating a display angle adjustment device according to one or more embodiments;

FIG. 5 is a plan view illustrating a display angle adjustment device according to one or more embodiments;

FIG. 6 is a view illustrating a display angle adjustment device of which a partial configuration is exploded according to one or more embodiments;

FIG. 7 is a cross-sectional view illustrating portion A shown in FIG. 5;

FIG. 8 is a cross-sectional view along line B-B′ shown in FIG. 5;

FIG. 9 is a view illustrating a gravity compensation unit of a display angle adjustment device according to one or more embodiments;

FIG. 10 is a block diagram illustrating a display angle adjustment device according to one or more embodiments;

FIG. 11 is a view provided to explain a pitch motion of a display caused by a display angle adjustment device according to one or more embodiments;

FIG. 12 is a view provided to explain a yaw motion of a display caused by a display angle adjustment device according to one or more embodiments; and

FIGS. 13 and 14 are views provided to explain a roll motion of a display caused by a display angle adjustment device according to one or more embodiments.

### DETAILED DESCRIPTION

The embodiments described in the present disclosure and the configurations illustrated in the drawings are provided only as one or more examples, and at a time of filing of the disclosure, there may be various modifications replaceable with the embodiments and the drawings in the disclosure.

In the disclosure, like reference numerals or symbols in each of the drawings substantially indicate like components or elements performing like functions.

Terms used herein are used to describe the embodiments, and are not intended to limit and/or restrict the subject matter of the disclosure. Unless explicitly stated otherwise, singular forms may include plural forms as well. In the disclosure, terms such as “include,” or “have” and the like are used to indicate the presence of stated features, numbers, steps, operations, elements, components or a combination thereof, and do not imply exclusion of the presence or addition of one or more different features, numbers, steps, operations, elements, components or a combination thereof.

In the disclosure, terms including ordinal numbers such as “1^{st},” “2^{nd},” and the like may be used to describe various elements, but not to limit the elements. The terms used herein are merely used to differentiate one element from another. For example, a first element may be referred to as a second element, and similarly, a second element may be referred to as a first element without departing from the scope of the right to the subject matter of the disclosure. The term “and/or” includes a combination of a plurality of stated relevant elements or any one of the plurality of stated relevant elements.

In the disclosure, terms such as “front end,” “rear end,” “upper portion,” “lower portion,” “front surface,” “rear surface,” “upper end,” “lower end,” and the like are defined with respect to the drawings, and are not intended to limit the shape and position of each of the elements.

Hereafter, a display angle adjustment device according to one or more embodiments is described in detail with reference to the accompanying drawings.

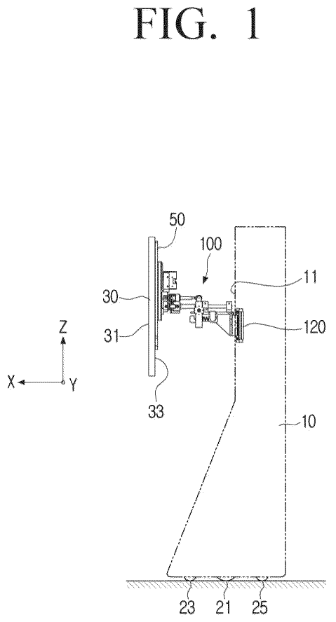

FIG. 1 is a view illustrating an example of a display angle adjustment device installed in a mobile robot according to one or more embodiments.

Referring to FIG. 1, the display angle adjustment device 100 may cause a display 30 to perform a pitch motion, a yaw motion, a combination of a pitch motion and a yaw motion, a roll motion such that the display 30 is adjustable at various angles. The display angle adjustment device 100 may adjust the display 30 at various angles based on a compact size and small power to provide convenience to the user.

The display angle adjustment device 100 may rotate (pitch) the display 30 around the Y axis of FIG. 1 to adjust the angle of the display 30. The display angle adjustment device 100 may rotate (yaw) the display 30 around the Z axis of FIG. 1 to adjust the angle of the display 30. The display angle adjustment device 100 may rotate (combine a pitch and a yaw) the display 30 around the Y axis and the Z axis of FIG. 1 at the same time to adjust the angle of the display 30. The display angle adjustment device 100 may rotate (roll) the display 30 around the X axis of FIG. 1 to adjust the angle of the display 30.

The display angle adjustment device 100 may connect the display 30 to a mobile robot 10. The mobile robot 10 may be provided, in the lower portion thereof, with a plurality of driving wheels 21 and a plurality of idle wheels 23, 25 disposed respectively in front of and behind the plurality of driving wheels 21.

Vibrations generated at a time of travel of the mobile robot 10 may be transferred to the display angle adjustment device 100. The display angle adjustment device 100 may include a vibration absorbing structure capable of absorbing the vibrations transferred from the mobile robot 10. Accordingly, the display angle adjustment device 100 may absorb the vibrations transferred to the display angle adjustment device 100 to mitigate or minimize a shake of the display 30, at a time when the mobile robot 10 travels. The vibration absorbing structure is described in detail hereafter.

The display 30 may be connected to the mobile robot 10 by the display angle adjustment device 100. The display angle adjustment device 100 may be coupled to a front surface 11 of the mobile robot 10 through a mounting part 120.

In the disclosure, the display angle adjustment device 100 is mounted on the mobile robot 10, for example, but not limited thereto. The display angle adjustment device 100, for example, may be mounted on a fixed structure such as a wall or on furniture such as a desk that is not frequently moved. In this case, the display angle adjustment device 100 may connect the display 30 to a wall or a desk.

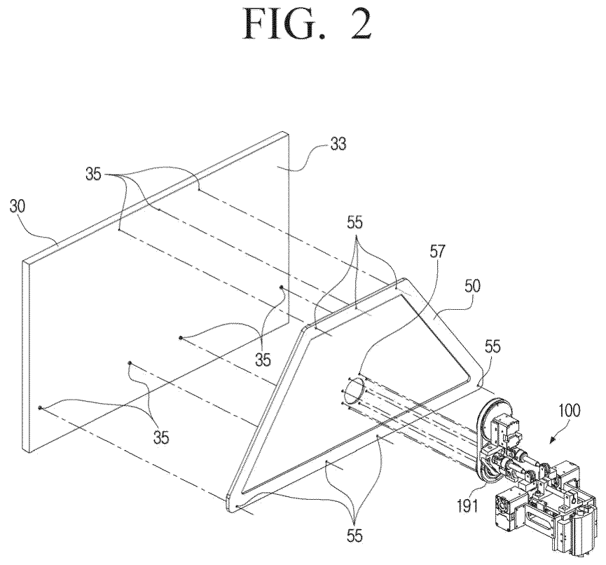

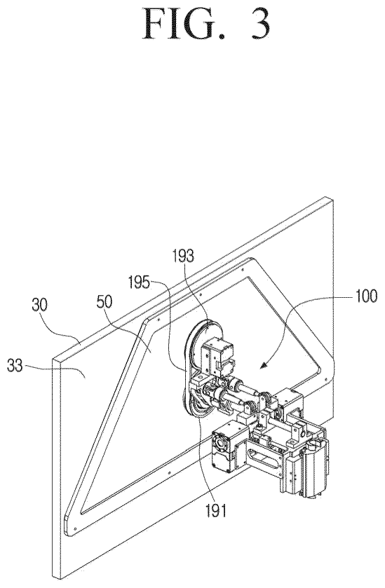

FIG. 2 is an exploded view illustrating an example of a display angle adjustment device connected to a display through a holder according to one or more embodiments. FIG. 3 is an assembly view illustrating an example of a display angle adjustment device connected to a display through a holder according to one or more embodiments.

Referring to FIG. 2, the display angle adjustment device 100 may be connected to the display 30 by a holder 50. The holder 50 may be connected to a rear surface 33 of the display 30 through a plurality of fasteners (hereafter, referred to as a “screw”).

The holder 50 may be provided with a plurality of first penetrating holes 55, through which a plurality of screws passes and which is spaced apart from one another in a portion adjacent to the upper edge of the holder 50 and a portion adjacent to the lower edge of the holder 50 respectively. A plurality of first fastening holes 35 corresponding to the first penetrating holes 55 may be provided on the rear surface 33 of the display 30.

The holder 50 may be formed into a plate having a rhombus shape of which the lower edge is longer than the upper edge to support the upper portion, the left side of the lower portion, and the right side of the lower portion of the rear surface 33 of the display 30. Accordingly, the holder 50 may support the display 30 more reliably than a holder supporting a central portion of the rear surface 33 of the display 30 only.

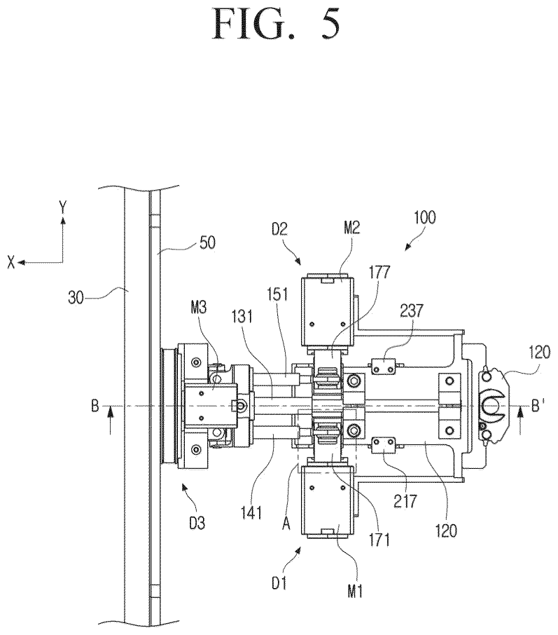

The display angle adjustment device 100 may be connected with the holder 50 through a driven pulley 191 as part of the elements constituting the display angle adjustment device 100. The holder 50 may be provided with a plurality of second penetrating holes 57 that is formed in an approximately central portion circumferentially. The driven pulley 191 may be provided with a plurality of second fastening holes 191a (see FIG. 5) corresponding to the plurality of second penetrating holes 57.

Referring to FIG. 3, the driven pulley 191 may receive the power of a driving pulley 193 through a belt 195 and may be rotated. The holder 50 may be rotated together with the driven pulley 191. Accordingly, the display 30 connected with the holder 50 may be rotated in the direction where the driven pulley 191 is rotated such that the pose of the display 30 is changed horizontally and perpendicularly.

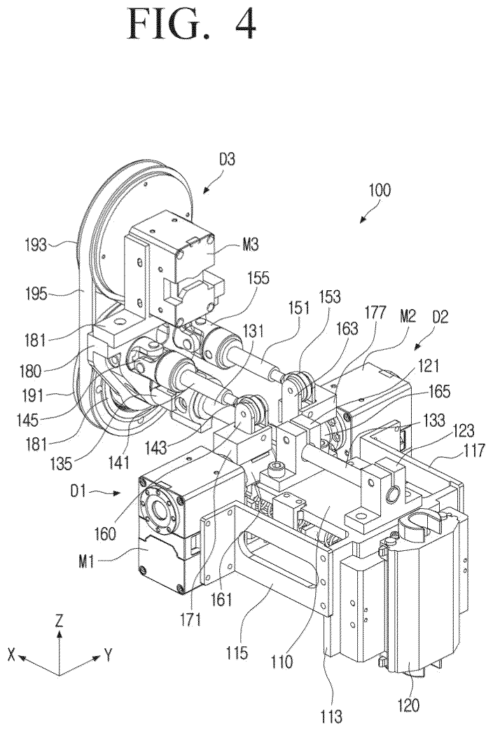

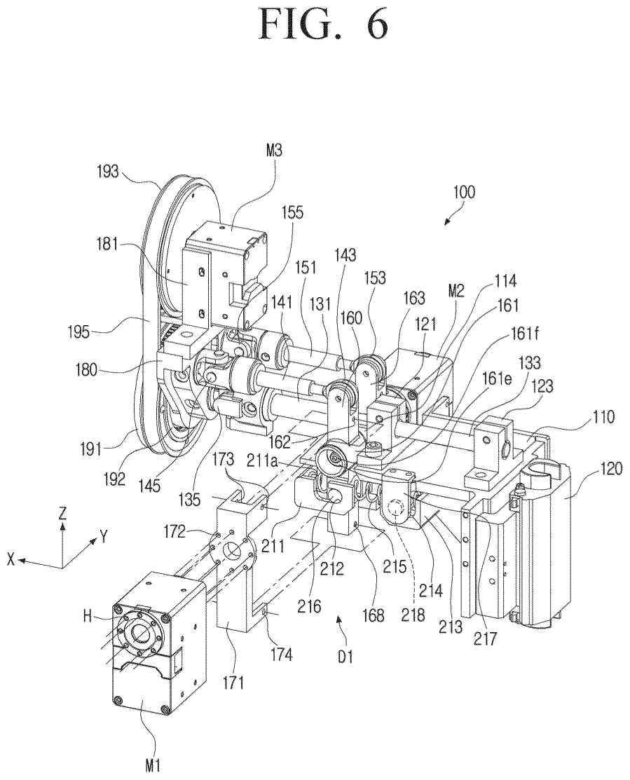

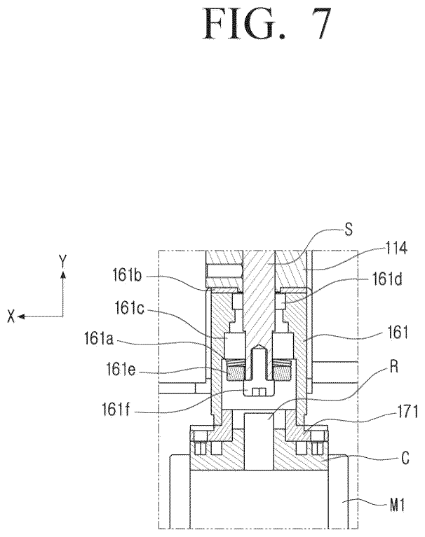

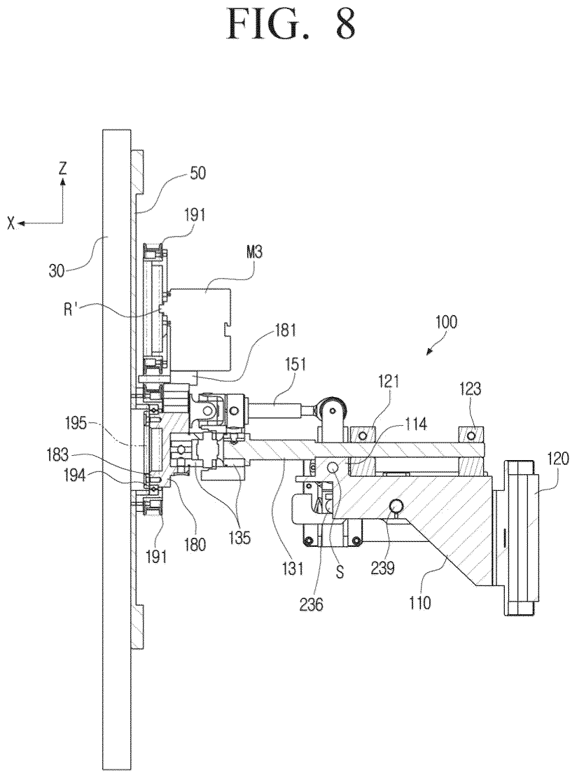

FIG. 4 is a view illustrating a display angle adjustment device according to one or more embodiments. FIG. 5 is a plan view illustrating a display angle adjustment device according to one or more embodiments. FIG. 6 is a view illustrating a display angle adjustment device of which a partial configuration is exploded according to one or more embodiments. FIG. 7 is a cross-sectional view illustrating portion A shown in FIG. 5. FIG. 8 is a cross-sectional view along line B-B′ shown in FIG. 5.

Referring to FIGS. 4 and 5, the display angle adjustment device 100 may include a base 110, a mounting part 120 coupled to a rear portion 113 of the base 110, a fixed shaft 131 coupled to the base 110, a first driving unit D1 (e.g., driver) and a second driving unit D2 for performing pitch and yaw motions of the display 30, and a third driving unit D3 for performing a roll motion of the display 30. The first driving unit D1 and the second driving unit D2 may be disposed on one side and the other side of the base 110 and may be disposed symmetrically with respect to the base 110. The first driving unit D1 and the second driving unit D2 may include a first driving motor M1 and a second driving motor M2 providing power for pitch and yaw motions of the display 30. The third driving unit D3 may include a third driving motor M3 providing power for a roll motion of the display 30.

The rear portion of the fixed shaft 131 may be clamped by a first clamp 121 and a second clamp 123 that are disposed with a gap therebetween on the upper surface of the base 110 along the X-axis direction. Accordingly, the fixed shaft 131 may be fixed to the base 110 along the X-axis direction.

One end portion of a first universal joint 135 may be coupled to the front end of the fixed shaft 131. The other end portion of the first universal joint 135 may be coupled to a connection block 180. Accordingly, the fixed shaft 131 may be connected with the connection block 180 by the first universal joint 135. A support block 181 to which the third driving motor M3 is installed may be provided in the upper portion of the connection block 180.

Referring to FIGS. 6 and 7, the first driving unit D1 may include a first driving motor M1, a first interfering member 171, a first swiveling member 160, and a first movable rod 141.

The first driving motor M1 may be connected to one side of the rear portion 113 the base 110 by a first connection plate 115. The first driving motor M1 may be driven clockwise and counterclockwise. A driving shaft R of the first driving motor M1 may be disposed along the Y-axis direction. The driving shaft R of the first driving motor M1 may be coupled with a coupling part C of the first driving motor M1. Accordingly, the coupling part C of the first driving motor M1 may be rotated together with the driving shaft R of the first driving motor M1 clockwise and counterclockwise.

The first interfering member 171 may transfer the power of the first driving motor M1 to the first swiveling member 160. The central portion of the first interfering member 171 may be connected with the coupling part C of the first driving motor M1. A plurality of screws may be inserted through a plurality of penetrating holes H of the first driving motor M1 and may be fastened to a plurality of fastening holes 172 of the first interfering member 171. Accordingly, the first interfering member 171 may be rotated in the same direction as the direction in which the driving shaft R of the first driving motor M1 is rotated.

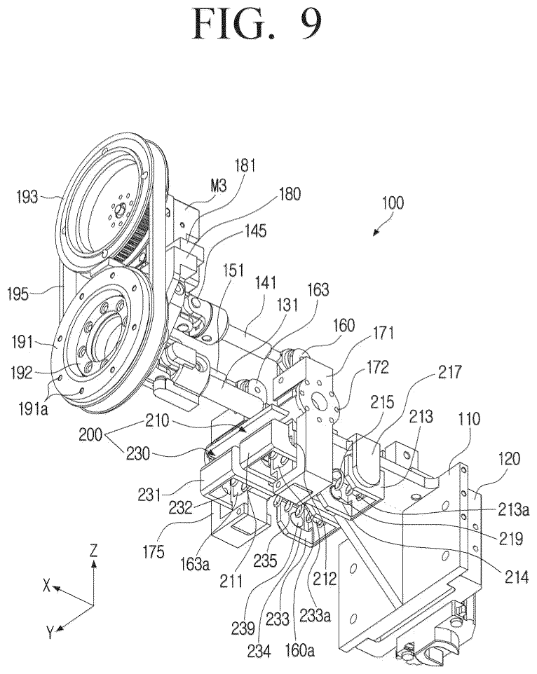

The first interfering member 171 may be connected with the first swiveling member 160 to transfer the rotational force of the first driving motor M1 to the first swiveling member 160. The upper portion and the lower portion of the first interfering member 171 may be connected to the upper portion and the lower portion of the first swiveling member 160 respectively. In this case, the plurality of screws may be fastened to a plurality of fastening holes 162, 168 of the first swiveling member 160 respectively through a plurality of penetrating holes 173, 174 of the first interfering member 171. Accordingly, the first swiveling member 160 may be rotated around a central shaft S (see FIG. 9) clockwise and counterclockwise.

The first swiveling member 160 may include a cylindrical part 161 into which one side of the central shaft S is inserted. The cylindrical part 161 of the first swiveling member 160 may be disposed on one side of a front end portion 114 of the base 110. A second swiveling member 163 included in the second driving unit D2 may include a configuration substantially the same as that of the first swiveling member 160. A cylindrical part of the second swiveling member 163 may be disposed on the other side of the front end portion 114 of the base 110. The other side of the central shaft S may be inserted into the cylindrical part of the second swiveling member 163. Accordingly, the central shaft S may be a rotation center of the first swiveling member 160 and the second swiveling member 163.

A vibration absorbing structure may be provided inside the cylindrical part 161 of the first swiveling member 160. In the case where the display 30 is installed in a mobile objet, e.g., a mobile robot 10 (see FIG. 1) through the display angle adjustment device 100, the vibration absorbing structure is a structure capable of mitigating or minimizing a shake of the display 30, caused by vibrations that are generated when the mobile robot 10 travels.

Referring to FIG. 7, the vibration absorbing structure may include an elastic member 161a, a frictional member 161b disposed between the cylindrical part 161 of the first swiveling member 160 and the front end portion 114 of the base 110, and a first bearing 161c and a second bearing 161d disposed between the central shaft S and the cylindrical part 161 of the first swiveling member 160.

The elastic member 161a may be coupled to the central shaft S and may press the cylindrical part 161 of the first swiveling member 160 against the front end portion 114 of the base 110. The elastic member 161a may be supported by a coupling ring 161e not to separate from the central shaft S. The coupling ring 161e may be coupled to the central shaft S by a fixing bolt 161f fastened to the end portion of the central shaft S. The elastic member 161a may be a spring lock washer.

The frictional member 161b supports the cylindrical part 161 of the first swiveling member 160 such that the cylindrical part 161 of the first swiveling member 160 is rotated in the state where the cylindrical part 161 of the first swiveling member 160 is pressed against the front end portion 114 of the base 110 based on elastic force of the elastic member 161a. Torque of the first driving motor M1 is greater than elastic force acting on the cylindrical part 161 of the first swiveling member 160. Accordingly, the first swiveling member 160 may overcome elastic force of the elastic member 161a and be rotated clockwise and counterclockwise.

The frictional member 161b produces friction against the cylindrical part 161 of the first swiveling member 160 when the cylindrical part 161 of the first swiveling member 160 is rotated. In this case, the frictional member 161b may be formed of a material of durability, e.g., brass.

The first bearing 161c may be disposed close to the elastic member 161a. The first bearing 161c may be an angular contact ball bearing that supports the cylindrical part 161 of the first swiveling member 160 such that cylindrical part 161 of the first swiveling member 160 is rotated smoothly, while withstanding thrust load applied along the shaft direction of the central shaft S by elastic force of the elastic member 161a.

The second bearing 161d may be disposed close to the frictional member 161b. The second bearing 161d may be an ordinary ball bearing.

Referring to FIG. 6, a rear end 143 of the first movable rod 141 may be hinge-connected to one end of the first swiveling member 160. The first movable rod 141 may be disposed in parallel with the fixed shaft 131. The first movable rod 141 may be moved along the X-axis direction in link with rotation of the first swiveling member 160. For example, as the first swiveling member 160 is rotated clockwise (see FIG. 4), the first movable rod 141 may be moved back toward the mounting part 120. As the first swiveling member 160 is rotated counterclockwise (see FIG. 4), the first movable rod 141 may be moved forth toward the connection block 180.

One end portion of a second universal joint 145 may be coupled to the front end of the first movable rod 141. The second universal joint 145 may be coupled with the connection block 180. Accordingly, the first movable rod 141 may be connected with the connection block 180 by the second universal joint 145. As the first movable rod 141 is moved forward and backward along the X-axis direction in link with the first swiveling member 160, the connection block 180 may pivot with respect to the first universal joint 135 as a pivot point.

The driven pulley 191 of the third driving unit D3 may be rotatably coupled to the connection block 180. The driven pulley 191 may be connected to the holder 50 coupled to the rear surface 33 of the display 30. Accordingly, when a second movable rod 151 of the second driving unit D2 is moved forward and backward at the same time as the first movable rod 141 of the first driving unit D1 is moved forward and backward, the display 30 may perform one of a pitch motion, a yaw motion, and a combination of a pitch motion and a yaw motion and may be adjusted to maintain various angles.

The second driving unit D2 disposed to be symmetric to the first driving unit ( ) with respect to the front end portion 114 of the base 110 may include a configuration that is substantially the same as that of the first driving unit D1. Accordingly, the structure of the second driving unit D2 is schematically described.

The second driving unit D2 may include a second driving motor M2, a second interfering member 177 (see FIG. 5), a second swiveling member 163, and a second movable rod 151.

The second driving motor M2 may be connected to the other side of the rear portion 113 of the base 110 through a second connection plate 117. Like the first swiveling member 160, the second swiveling member 163 may be provided with a vibration absorbing structure inside the cylindrical part thereof.

A rear end 153 of the second movable rod 151 may be hingedly connected to the upper end of the second swiveling member 163. One end portion of a third universal joint 155 may be coupled to the front end of the second movable rod 151. The third universal joint 155 may be coupled with the connection block 180. Accordingly, the second movable rod 151 may be connected with the connection block 180 by the third universal joint 155. As the second movable rod 151 is moved forward and backward along the X-axis direction in link with the second swiveling member 163, the connection block 180 may pivot with respect to the first universal joint 135 as a pivot point.

Referring to FIG. 8, the third driving unit D3 may include a third driving motor M3, a driving pulley 193, a driven pulley 191 and a belt 195.

The third driving motor M3 may be fixed to the support block 181. The third driving motor M3 may be driven clockwise and counterclockwise.

The driving pulley 193 may be coupled to a driving shaft R′ of the third diving motor M3. Accordingly, the driving pulley 193 may be rotated in a clockwise direction and a counterclockwise direction that are the same as the directions in which the third driving motor M3 is driven.

The driven pulley 191 may be rotatably coupled to a front end portion 183 of the connection block 180. In this case, a third bearing 194 may be disposed between the front end portion 183 of the connection block 180 and the driven pulley 191. The third bearing 194 may be a ball bearing. The driven pulley 191 may receive power from the driving pulley 193 through the belt 195. The driven pulley 191 may be rotated in the same direction as the direction in which the driving pulley 193 is rotated.

The driven pulley 191 may be coupled with the holder 50. Accordingly, the holder 50 may be rotated together the driven pulley 191 in the same direction as the direction in which the driven pulley 191 is rotated. The display 30 may be connected with the driven pulley 191 by the holder 50. Accordingly, as the driven pulley 191 is rotated clockwise and counterclockwise, the display 30 may perform a roll motion.

As the display 30 performs the roll motion, the pose of the display 30 may be changed horizontally, vertically, or diagonally. The display 30 may be rotated by 90 degrees clockwise or counterclockwise at a time when the direction of the display 30 is changed from a horizontal direction to a vertical direction. A diagonal direction may be any angle between 0 and 90 degrees.

Hereafter, a gravity compensation unit (or gravity compensation interface) of the display angle adjustment device 100 is described with reference to the drawing. FIG. 9 is a view illustrating a gravity compensation unit of a display angle adjustment device according to one or more embodiments.

The self-weight of the display 30 may be increased in proportion to the size of the display 30. In the case of a large-sized display 30 (e.g., equal to or greater than 27 inches), a screen-displaying front surface 31 of the display 30 connected to the display angle adjustment device 100 may be tilted toward the ground surface because of the self-weight of the display 30.

The display angle adjustment device 100, as illustrated in FIG. 9, may include a gravity compensation unit 200 capable of compensating gravity caused by the self-weight of the display 30. The display angle adjustment device 100 may mitigate or minimize the tilt or sag of the front surface 31 of a large-sized display 30 toward the ground surface, caused by the self-weight of the display 30, through the gravity compensation unit 200.

Referring to FIG. 9, the gravity compensation unit 200 may include a first gravity compensation unit 210 provided to the first driving unit D1, and a second gravity compensation unit 230 provided to the second driving unit D2.

The first gravity compensation unit 210 may include a first fixation block 211 disposed in the lower portion of the first swiveling member 160 and a second fixation block 213 disposed in the lower portion of the base 110, and a first coil spring 215 disposed elastically between the first fixation block 211 and the second fixation block 213.

The first fixation block 211 may have a pair of first side grooves 212, on both lateral surfaces thereof. A pair of first holding protrusions 216 having a cylindrical shape and protruding on both sides of the first swiveling member 160 may be slidably coupled to the pair of first side grooves 212. The pair of first holding protrusions 216 may be disposed on the same axis (e.g., a Y axis). Accordingly, the first fixation block 211 may be movably connected to the lower portion of the first swiveling member 160.

The second fixation block 213 may have a pair of second side grooves 214, on both lateral surfaces thereof. A second holding protrusion 218 of a first fixing piece 217 fixed to the base 110 may be slidably coupled to one of the pair of second side grooves 214, and a third holding protrusion 219 formed at the base 110 may be slidably coupled to the remainder of the pair of second side grooves 214. The second holding protrusion 218 and the third holding protrusion 219 may be disposed on the same axis (e.g., a Y axis). Accordingly, the second fixation block 213 may be movably coupled to the first fixing piece 217 and the base 110.

One end of the first coil spring 215 may be fixed to a first fixing protrusion 211a inside the first fixation block 211, and the other end of the first coil spring 215 may be fixed to a second fixing protrusion 213a inside the second fixation block 213. In this case, the first coil spring 215 may be disposed in the state where the first coil spring 215 penetrates a hole 160a formed in the lower portion of the first swiveling member 160.

The first gravity compensation unit 210 may elastically support the first swiveling member 160 such that the first swiveling member 160 is not rotated counterclockwise by the self-weight of the display 30. Accordingly, the first driving motor M1 may mitigate or reduce a load caused by the self-weight of the display 30 when the first driving motor M1 is driven to perform a pitch motion, a yaw motion and a combination of a pitch motion and a yaw motion of the display 30.

The second gravity compensation unit 230 may include a configuration that is substantially the same as that of the first gravity compensation unit 210. The second gravity compensation unit 230 may include a third fixation block 231 disposed in the lower portion of the second swiveling member 163 and a fourth fixation block 233 disposed in the lower portion of the base 110, and a second coil spring 235 elastically disposed between the third fixation block 231 and the fourth fixation block 233.

The third fixation block 231 may have a pair of third side grooves 232, on both lateral surfaces thereof. A pair of fourth holding protrusions 236 (see FIG. 8) having a cylindrical shape and protruding on both sides of the second swiveling member 163 may be slidably coupled to the pair of third side grooves 232. The pair of fourth holding protrusions 236 may be disposed on the same axis (e.g., a Y axis). Accordingly, the third fixation block 231 may be movably connected to the lower portion of the second swiveling member 163.

The fourth fixation block 233 may have a pair of fourth side grooves 234, on both lateral surfaces thereof. A fifth holding protrusion (not illustrated) of a second fixing piece (not illustrated) fixed to the base 110 may be slidably coupled to one of the pair of fourth side grooves 234, and a sixth holding protrusion 239 formed at the base 110 may be slidably coupled to the remainder of the pair of fourth side grooves 234. The fifth holding protrusion and the sixth holding protrusion 239 may be disposed on the same axis (e.g., a Y axis). Accordingly, the fourth fixation block 233 may be movably coupled to the second fixing piece and the base 110.

One end of the second coil spring 235 may be fixed to a third fixing protrusion (not illustrated) inside the third fixation block 231, and the other end of the second coil spring 235 may be fixed to a second fixing protrusion 233a inside the fourth fixation block 233. In this case, the second coil spring 235 may be disposed in the state where the second coil spring 235 penetrates a hole 163a formed in the lower portion of the second swiveling member 163.

The second gravity compensation unit 230 may elastically support the second swiveling member 163 such that the second swiveling member 163 is not rotated counterclockwise by the self-weight of the display 30. Accordingly, the second driving motor M2 may mitigate or reduce a load caused by the self-weight of the display 30 when the second driving motor M2 is driven to perform a pitch motion, a yaw motion and a combination of a pitch motion and a yaw motion of the display 30.

Hereafter, an example of a pitch motion, a yaw motion and a combination of a pitch motion and a yaw motion, and a roll motion of the display 30, performed by the display angle adjustment device 100 according to one or more embodiments, is described with reference to the drawing.

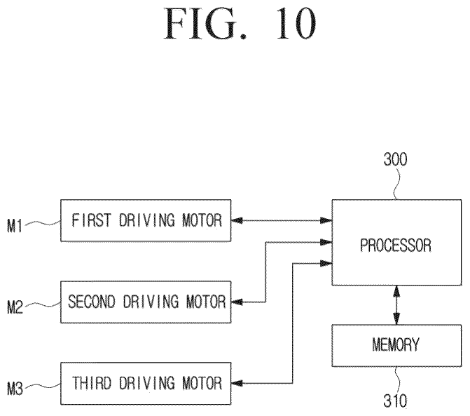

FIG. 10 is a block diagram illustrating a display angle adjustment device according to one or more embodiments.

The display angle adjustment device 100 according to one or more embodiments may further include a processor 300 for controlling the driving of the first driving motor M1, the second driving motor M2, and the third driving motor M3, and memory 310. The processor 300 and the memory 310 may be disposed at predetermined positions of the base 110. Additionally, the processor 300 and the memory 310 may also be provided to an object in which the display angle adjustment device 100 is installed, e.g., a mobile robot 10.

The processor 300 may be comprised of one processor or a plurality of processors. The one processor or the plurality of processors may include at least one of a central processing unit (CPU), a graphics processing unit (GPU), and a neural processing unit (NPU), but not be limited thereto. The CPU, as a generic-purpose processor capable of performing an AI computation as well as a normal computation, may efficiently execute a complex program through a multi-level cache structure. The CPU is advantageous in a series processing method enabling an organic connection between previous calculation results and following calculation results based on a consecutive calculation. The generic-purpose processor is not limited to the above-described examples, unless explicitly indicated as the above-described CPU.

The memory 310 is an element for storing various types of programs and data required for a pitch motion, a yaw motion, a combination of a pitch motion and a yaw motion, and a roll motion of the display 30. The memory 310 may include volatile memory or non-volatile memory. The programs may be stored in the memory 310 as software, and for example, include an operating system, middleware or and application.

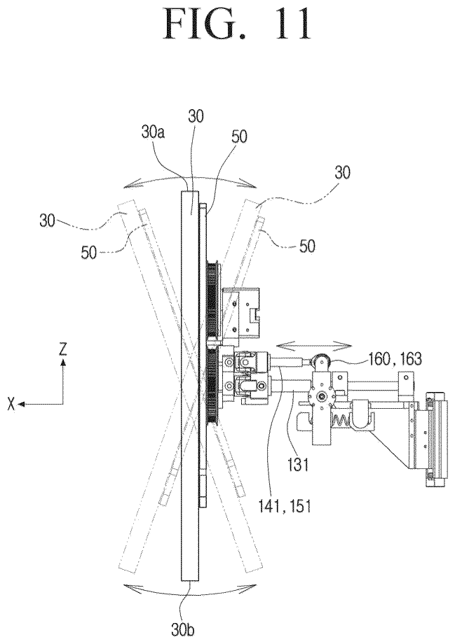

FIG. 11 is a view provided to explain a pitch motion of a display caused by a display angle adjustment device according to one or more embodiments.

Referring to FIG. 11, for a pitch motion of the display, the processor 300 controls the driving of the first driving motor M1 such that the first driving motor M1 is rotated counterclockwise, and controls the driving of the second driving motor M2 such that the second driving motor M2 is rotated counterclockwise.

The first swiveling member 160 and the second swiveling member 163 are rotated counterclockwise with respect to the Y axis by a predetermined angle. The first movable rod 141 and the second movable rod 151 are moved forth along the X-axis direction. In this case, the processor 300 may control the driving of the first driving motor M1 and the second driving motor M2 such that the first swiveling member 160 and the second swiveling member 163 are rotated by the same angle. Accordingly, the first movable rod 141 and the second movable rod 151 may be moved forth by the same distance.

Thus, based on the pitch motion where an upper side 30a of the display 30 is moved forth while a lower side 30b of the display 30 is moved back, the display 30 may be adjusted to rotate around the Y axis by a predetermine dangle.

The processor 300 may control the driving of the first driving motor M1 and the second driving motor M2 to perform the pitch motion of the display 30, where the upper side 30a of the display 30 is moved back while the lower side 30b of the display 30 is moved back.

For example, the processor 300 controls the driving of the first driving motor M1 such that the first driving motor M1 is rotated clockwise, and controls the driving of the second driving motor M2 such that the second driving motor M2 is rotated clockwise.

The first swiveling member 160 and the second swiveling member 163 are rotated clockwise with respect to the Y axis by a predetermined angle. The first movable rod 141 and the second movable rod 151 are moved back along the X-axis direction. In this case, the processor 300 may control the driving of the first driving motor M1 and the second driving motor M2 such that the first swiveling member 160 and the second swiveling member 163 are rotated by the same angle. Accordingly, the first movable rod 141 and the second movable rod 151 may be moved back by the same distance. Thus, based on the pitch motion where the upper side 30a of the display 30 is moved back while the lower side 30b of the display 30 is moved back, the angle of the display 30 may be adjusted.

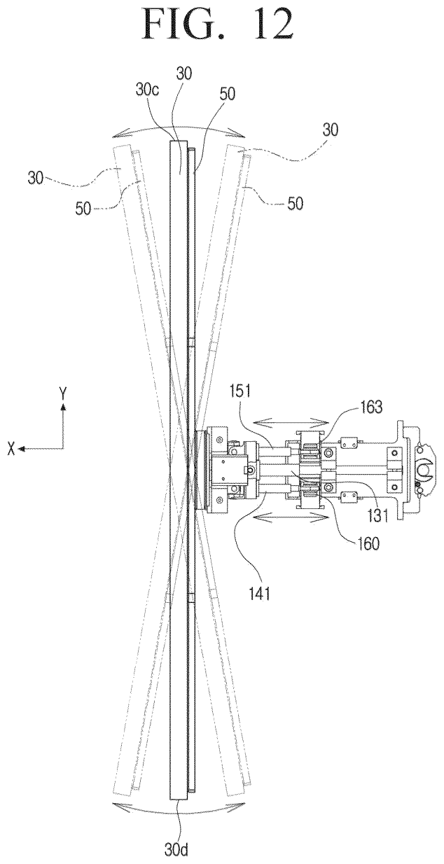

FIG. 12 is a view provided to explain a yaw motion of a display caused by a display angle adjustment device according to one or more embodiments.

Referring to FIG. 12, for a pitch motion of the display, the processor 300 controls the driving of the first driving motor M1 such that the first driving motor M1 is rotated counterclockwise, and controls the driving of the second driving motor M2 such that the second driving motor M2 is rotated clockwise.

The first swiveling member 160 is rotated counterclockwise with respect to the Y axis by a predetermined angle, and the first movable rod 141 is moved forth along the X-axis direction. The second swiveling member 163 is rotated clockwise with respect to the Y axis by a predetermined angle, and the second movable rod 151 is moved back along the X-axis direction. In this case, the processor 300 may control the driving of the first driving motor M1 such that the first swiveling member 160 is rotated by a first angle, and may control the driving of the second driving motor M2 such that the second swiveling member 163 is rotated by a second angle different from the first angle. In this case, the first angle may be greater than the second angle. Accordingly, the first movable rod 141 and the second movable rod 151 may be moved in an opposite direction by a different distance.

Thus, based on the yaw motion where a left side 30c of the display 30 is moved back while a right side 30d of the display 30 is moved forth, the display 30 may be adjusted to rotate around the Z axis by a predetermined angle.

The processor 300 may control the driving of the first driving motor M1 and the second driving motor M2 to perform the yaw motion of the display 30, where the left side 30c of the display 30 is moved forth while the right side 30d of the display 30 is moved back.

For example, the processor 300 controls the driving of the first driving motor M1 such that the first driving motor M1 is rotated clockwise, and controls the driving of the second driving motor M2 such that the second driving motor M2 is rotated counterclockwise.

The first swiveling member 160 is rotated clockwise with respect to the Y axis by a predetermined angle, and the first movable rod 141 is moved back along the X-axis direction. The second swiveling member 163 is rotated counterclockwise with respect to the Y axis by a predetermined angle, and the second movable rod 151 is moved forth along the X-axis direction. In this case, the processor 300 controls the driving of the first driving motor M1 such that the first swiveling member 160 is rotated by a third angle, and controls the driving of the second driving motor M2 such that the second swiveling member 163 is rotated by a fourth angle different from the third angle. The fourth angle may be greater than the third angle. Accordingly, the first movable rod 141 and the second movable rod 151 may be moved in an opposite direction by a different distance.

Thus, based on the yaw motion where the left side 30c of the display 30 is moved forth while the right side 30d of the display 30 is moved back, the angle of the display 30 may be adjusted.

Meanwhile, the display angle adjustment device 100 according to one or more embodiments may perform the pitch motion and the yaw motion of the display 30 at the same time to adjust the angle of the display 30.

The processor 300 may control the first driving motor M1 and the second driving motor M2 such that the first driving motor M1 and the second driving motor M2 are driven in the same direction. In this case, the processor 300 may control the first driving motor M1 and the second driving motor M2 such that the rotation angles of the first swiveling member 160 and the second swiveling member 163 being rotated in the same direction differ from each other. The first movable rod 141 and the second movable rod 151 may be moved respectively by a different distance while the first movable rod 141 and the second movable rod 151 are moved forth along the X axis.

Accordingly, the display 30 may adopt a third pose different from a first pose in the case where the pitch motion is only performed and a second pose in the case where the yaw motion is only performed. The first pose of the display 30 is a pose that is adopted when the display 30 is rotated around the Y axis by a predetermined angle. The second pose of the display 30 is a pose that is adopted when the display 30 is rotated around the Z axis by a predetermined angle. The third pose of the display 30 is a pose that is adopted when the display 30 is rotated around the Y axis and the Z axis at the same time by a predetermined angle.

As described above, the display angle adjustment device 100 according to one or more embodiments may cause the display 30 to perform a pitch motion, a yaw motion and a combination of a pitch motion and a yaw motion of the display 30 such that the display 30 is adjustable at various angles.

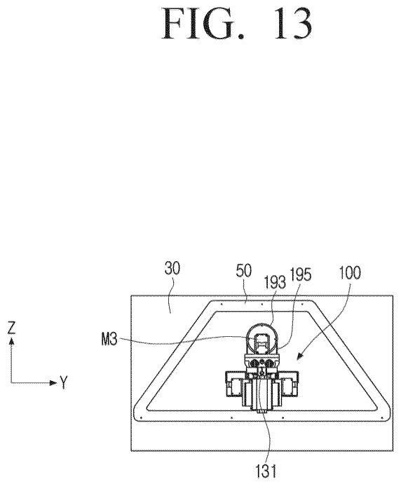

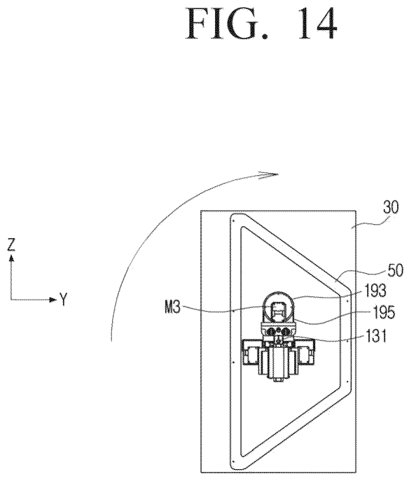

FIGS. 13 and 14 are views provided to explain a roll motion of a display caused by a display angle adjustment device according to one or more embodiments.

Referring to FIG. 13, the display 30 may be disposed horizontally. A horizontal disposition of the display 30 may mean a disposition of the display 30 at 0 degree. The processor 300 may control the third driving motor M3 such that the third driving motor M3 is driven clockwise. The driving pulley 193 is rotated clockwise by the third driving motor M3. The driven pulley 191 receives the rotational force of the driving pulley 193 through the belt 195 to rotate clockwise.

Referring to FIG. 14, the display 30 connected to the driven pulley 191 through the holder 50 may be rotated clockwise by a predetermined angle. In this case, the processor 300 may control the rotation direction and rotation times of the third driving motor M3 such that the display 30 is rotated clockwise by 90 degrees. In this case, the processor 300 may control the rotation direction and rotation times of the third driving motor M3 such that the display 30 is rotated counterclockwise by 90 degrees.

Additionally, the rotation angle of the display 30 being rotated around the X axis based on a roll motion is not limited to 90 degrees. For example, the processor 300 may control the driving of the third driving motor M3 such that the display 30 performs a roll motion clockwise and counterclockwise by another angle rather than 90 degrees.

As described above, the display angle adjustment device 100 according to one or more embodiments may perform a pitch motion, a yaw motion, a combination of a pitch motion and a yaw motion, and a roll motion of the display 30 such that the display 30 is adjustable at various angles and in various poses.

The display angle adjustment device 100 according to one or more embodiments may be provided with a gravity compensation unit 200 compensating the self-weight of the display 30. Accordingly, even in the case where the display angle adjustment device 100 is applied to a large-sized display, the display angle adjustment device 100 may support the large-sized display reliably and adjust the large-sized display such that the large-sized display may maintain various angles and poses.

The display angle adjustment device 100 according to one or more embodiments may include a separate cover such that the display angle adjustment device 100 may not be exposed outward. The cover may be formed to wrap the display angle adjustment device 100 entirely. The display angle adjustment device 100 may be protected from a shock applied from the outside and prevented from being contaminated with foreign substances, by the cover.

The display angle adjustment device 100 according to one or more embodiments includes the first driving unit D1, the second driving unit D2 and the third driving unit D3, but is not limited thereto. For example, in the case where the display 30 is used only horizontally or vertically, the display angle adjustment device 100 according to one or more embodiments may include the first driving unit D1 and the second driving unit D2 only, while excluding the third driving unit D3.

The display angle adjustment device 100 according to one or more embodiments may be directly connected to the display 30 without the holder 50. In this case, the driven pulley 191 may be directly connected to the rear surface 33 of the display 30 through a plurality of fasteners.

The display angle adjustment device 100 according to one or more embodiments may not be limitedly connected to a flat-panel display 30, but may be connected to a curved display of which a front surface and a rear surface have a predetermined curvature and adjust the angle of the display. In this case, the holder 50 may be formed to have a curvature corresponding to that of the rear surface of the curved display.

The display angle adjustment device 100 according to one or more embodiments may not be limitedly mounted in a mobile robot 10 but may be mounted in various types of mobile objects, e.g., a vehicle, a truck, a ship and the like. In this case, the display angle adjustment device 100 may absorb vibrations generated based on movement of a mobile object through a vibration absorbing structure to mitigate or minimize a shake of the display 30.

According to an embodiment, a display angle adjustment device includes: a base; a fixed shaft fixed to the base along an X-axis direction; a first driver provided on a first side of the base and including a first movable rod parallel with the fixed shaft; a second driver provided on a second side of the base such that the second driver is symmetrical to the first driver, the second driver including a second movable rod parallel with the fixed shaft; a connection block to which a front end of the fixed shaft, a front end of the first movable rod, and a front end of the second movable rod are pivot-connected respectively; and a holder connecting the connection block and a display, wherein the first movable rod and the second movable rod are configured to move along an X-axis direction to adjust an angle of the display.

According to an embodiment, a display angle adjustment device includes: a base; a first driver provided on a first side of the base; a second driver provided on a second side of the base such that the second driver is symmetrical to the first driver; a third driver provided at a front of the base; and a holder connecting the third driver and a display, wherein the first driver and the second driver rotate the display around an X axis and a Z axis, and wherein the third driver rotates the display around an Y axis.

While example embodiments of the disclosure are illustrated and described above, embodiments of the disclosure are not limited to the embodiments set forth herein, and certainly, various modifications thereof may be made by those skilled in the art to which the disclosure pertains, without departing from the scope of the disclosure, claimed in the section of claims, and should not be understood as separating from the technical spirit or prospect of the disclosure.

What is claimed is:

1. A display angle adjustment device comprising:
a base;
a fixed shaft fixed to the base along an X-axis direction;
a first driver provided on a first side of the base and comprising a first movable rod parallel with the fixed shaft;
a second driver provided on a second side of the base such that the second driver is symmetrical to the first driver, the second driver comprising a second movable rod parallel with the fixed shaft;
a connection block to which a front end of the fixed shaft, a front end of the first movable rod, and a front end of the second movable rod are pivot-connected respectively; and
a holder connecting the connection block and a display,
wherein the first movable rod and the second movable rod are configured to move along an X-axis direction to adjust an angle of the display.

2. The display angle adjustment device as claimed in claim 1, wherein the first movable rod and the second movable rod are configured to move by an identical distance in an identical direction along an X-axis direction to rotate the display around a Y axis.

3. The display angle adjustment device as claimed in claim 1, wherein the first movable rod and the second movable rod are configured to move in a different direction along an X-axis direction to rotate the display around a Z axis.

4. The display angle adjustment device as claimed in claim 1, wherein the first movable rod and the second movable rod are configured to move in an identical direction along an X-axis direction by a different distance to rotate the display around a Y axis and a Z axis.

5. The display angle adjustment device as claimed in claim 1, wherein the display angle adjustment device further comprises a third driver provided at the connection block to rotate the holder around a Y axis.

6. The display angle adjustment device as claimed in claim 1, wherein the display angle adjustment device further comprises a gravity compensation interface supporting the first movable rod and the second movable rod elastically in a direction where the first movable rod and the second movable rod are configured to move toward the holder along an X-axis direction.

7. The display angle adjustment device as claimed in claim 1, wherein the first driver comprises a first swiveling member hinge-connected to the first movable rod,
wherein the second driver comprises a second swiveling member hinge-connected to the second movable rod, and
wherein the display angle adjustment device further comprises:
a central shaft penetrating the base in the X-axis direction, and connected to rotation centers of the first swiveling member and the second swiveling member; and
a vibration absorbing structure elastically pressing the first swiveling member and the second swiveling member respectively against the base.

8. The display angle adjustment device as claimed in claim 7, wherein the vibration absorbing structure comprises:
a first elastic member and a second elastic member coupled to both ends of the central shaft respectively;
a first frictional member provided between the first swiveling member and the base;
a second frictional member provided between the second swiveling member and the base;
a first bearing provided between the first swiveling member and the central shaft and adjacent to the first elastic member, and a second bearing adjacent to the first frictional member; and
a third bearing provided between the second swiveling member and the central shaft and adjacent to the second elastic member, and a fourth bearing adjacent to the second frictional member.

9. The display angle adjustment device as claimed in claim 8, wherein the first bearing and the third bearing are angular contact ball bearings.

10. The display angle adjustment device as claimed in claim 8, wherein materials of the first frictional member and the second frictional member are brass.

11. The display angle adjustment device as claimed in claim 8, wherein the first elastic member and the second elastic member are spring washers.

12. The display angle adjustment device as claimed in claim 1, wherein the holder has a rhombus shape of which a lower edge corresponding to a lower side of the display has a length greater than a length of an upper edge corresponding to an upper side of the display, and
wherein both end portions of the lower side of the holder are fixed to a lower end portion of a left side of the display and a lower end portion of a right side of the display respectively.

13. The display angle adjustment device as claimed in claim 1, wherein a front end of the fixed shaft, a front end of the first movable rod, and a front end of the second movable rod are connected respectively by first, second and third universal joints.

14. A display angle adjustment device comprising:
a base;
a first driver provided on a first side of the base;
a second driver provided on a second side of the base such that the second driver is symmetrical to the first driver;
a third driver provided at a front of the base; and
a holder connecting the third driver and a display,
wherein the first driver and the second driver rotate the display around an X axis and a Z axis, and
wherein the third driver rotates the display around an Y axis.

15. The display angle adjustment device as claimed in claim 14, wherein the first driver comprises a first movable rod connected to the holder,
wherein the second driver comprises a second movable rod parallel with the first movable rod and connected to the holder, and
wherein the display angle adjustment device further comprises a gravity compensation interface elastically supporting the first movable rod and the second movable rod in a direction where the first movable rod and the second movable rod are configured to move along an X-axis direction.
